(19) United States
(12) Patent Application Publication
(10) Pub. No.: US 2026/0084686 A1
(43) Pub. Date: Mar. 26, 2026

(54) ELECTRIC DRIVE SYSTEM COUPLED TO A POWER TAKE-OFF OF AN INTERNAL COMBUSTION VEHICLE

(71) Applicants: Rustee Stubbs, Washington, UT (US); Kenneth Miller, Washington, UT (US)

(72) Inventors: Rustee Stubbs, Washington, UT (US); Kenneth Miller, Washington, UT (US)

(21) Appl. No.: 19/335,318

(22) Filed: Sep. 22, 2025

Related U.S. Application Data
(60) Provisional application No. 63/697,124, filed on Sep. 20, 2024.
(60) Provisional application No. 63/742,782, filed on Jan. 7, 2025.

(51) Int. Cl. B60W 20/15; B60W 10/02; B60W 10/06; B60W 10/08; B60W 10/10; B60W 20/40

(52) U.S. Cl. CPC B60W 20/15; B60W 10/02; B60W 10/06; B60W 10/08; B60W 10/10; B60W 20/40

(57) ABSTRACT

A hybrid system comprises a vehicle having a power take-off (PTO) and a controller (e.g., electronic control module/unit (ECM/U)) configured to: (1) control the on/off state of the ICE, (2) control rotation of the ICE through a clutch actuator or automatic transmission controller, and (3) control the on/off state of an electric motor, the electric motor coupled to the PTO to drive a transmission of the vehicle, thereby moving the vehicle independent of the state of the ICE. The hybrid system may allow the vehicle to move via the ICE, electric motor, or combination of the two.

### CROSS-REFERENCE TO RELATED APPLICATIONS

This application claims the benefit of U.S. Provisional App. Ser. No. 63/742,782 filed on Jan. 7, 2025, and further claims the benefit of U.S. Provisional App. Ser. No. 63/697,124 filed on Sep. 20, 2024, both of which are incorporated herein by reference.

### TECHNICAL FIELD

The present disclosure relates to hybrid vehicles. More particularly, the present disclosure relates to an electric drive system configured to control the operation of an internal combustion engine.

### BACKGROUND

Internal combustion engine (ICE) vehicles are the most prevalent on the road today, with a steady increase in electric vehicles. However, despite the increase in electric vehicles, ICE vehicles remain the most prevalent due to the limitations of electric vehicles, including lack of range, charging time, and lack of charging stations, among other things. While ICE vehicles remain the most prevalent, they are far from efficient. Depending on the size of fuel tank and the efficiency of the vehicle, the range of an ICE vehicle significantly varies. Additionally, ICE vehicles may create emissions that are not desirable.

Hybrid vehicles have attempted to solve the limitations of both ICE and electric vehicles by combining the two. Hybrid vehicles typically utilize an ICE and one or more electric motors powered by batteries, include regenerative braking, and typically include an automatic start/stop for the ICE, stopping the ICE when the vehicle is not moving.

Despite hybrid vehicles increasing fuel efficiency in passenger cars, hybrid vehicles have not successfully been used in commercial diesel trucks. While attempts have been made, several shortcomings caused hybrid commercial diesel trucks to fail. For example, commercial diesel trucks typically drive long distances on interstates without much braking. Because hybrid vehicles in the art rely on regenerative braking to charge the batteries used by the electric motor, the majority of travel by hybrid commercial diesel trucks still relied mainly on the ICE. The increased weight and expense of the battery system, with little benefit, caused hybrid commercial diesel trucks to, for the most part, fail to see commercial success.

Accordingly, there is a need for a hybrid system for commercial trucks that is capable of reducing fuel consumption, reducing harmful emissions, reducing wear on the ICE and drivetrain, while increasing power availability. The present disclosure seeks to solve these and other problems.

### SUMMARY OF EXAMPLE EMBODIMENTS

In some embodiments, a hybrid system comprises a vehicle having a power take-off (PTO) and a controller (e.g., electronic control module/unit (ECM/U)) configured to: (1) control the on/off state of the ICE, (2) control rotation of the ICE through a clutch actuator or automatic transmission controller, and (3) control the on/off state of an electric motor, the electric motor coupled to the PTO to drive a transmission of the vehicle, thereby moving the vehicle independent of the state of the ICE. In some embodiments, a gearbox may be interposed between the PTO and the electric motor.

In vehicles with a manual transmission, the ECM/U of the hybrid system, in some embodiments, may be configured to electronically control the connection/disconnection of the PTO as well as controlling the clutch engagement/disengagement based upon power demand from the driver, battery state of charge, operating temperatures, malfunctions, etc. The ECM/U is also configured to control the start/stop status of the ICE.

In vehicles with an automatic transmission, the ECM/U of the hybrid system, in some embodiments, may be configured to electronically control the connection/disconnection of the PTO as well as controlling the torque converter engagement/disengagement and gear selection of the automatic transmission based upon power demand from the driver, battery state of charge, operating temperatures, malfunctions, etc. The ECM/U is also configured to control the start/stop status of the ICE.

In some methods of use, the hybrid system may comprise the following steps: first the ECM/U reads the status of vehicle and various components; next, the ECM/U checks to see if the torque request is above 75%. If the torque request is above the threshold, and safety checks are cleared, the ECM/U sends a signal to run the ICE and engage the clutch/torque converter, and apply the throttle to the ICE. If the battery is above a predetermined state of charge, then the electric motor may apply torque to the transmission to reduce fuel consumption. If the state of charge is below a predetermined threshold, then a negative torque is applied to the transmission to charge the batteries.

Returning to the first step, if the torque request is less than 75% (or other threshold set by the user), the system determines if the ICE is at idle speed. If at idle, and safety checks are cleared, the ECM/U engages the PTO and the electric motor applies torque to the PTO to reduce fuel consumption. The ECM/U may be configured to shut off fuel injectors to the ICE, reducing fuel consumption while at idle. If the system determines that the ICE is not at idle, and safety checks are cleared, the ECM/U engages the PTO, disengages the clutch/torque converter, stops the ICE, and the electric motor applies torque to the transmission. If the torque request is below 1% (or other threshold set by the user), a negative torque is applied, along with regenerative braking, to thereby reduce the speed of the vehicle while simultaneously charging the batteries.

In some embodiments, a hybrid system comprises an electric motor, a motor controller, a water cooling system, and ECM/U, a clutch actuator (for manual transmissions), a PTO air/electric solenoid, an electric hydraulic pump for power steering, an electric heater/air conditioner for climate control, an electric air compressor for air supply, a battery with a battery management system (BMS), an isolation monitoring device (IMD), and hood/enclosures with safety switches.

### BRIEF DESCRIPTION OF THE DRAWINGS

FIG. 1 illustrates a block diagram of a hybrid system;

FIG. 2 illustrates a block diagram of a hybrid system;

FIG. 3 illustrates a flow chart of a method of use of a hybrid system; and

FIG. 4 illustrates a block diagram of a hybrid system.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a hybrid system for commercial trucks that is capable of reducing fuel consumption, reducing harmful emissions, reducing wear on the ICE and drivetrain, while increasing power availability. The hybrid system disclosed herein solves these and other problems.

In some embodiments, a hybrid system comprises a vehicle having a power take-off (PTO) and a controller (e.g., electronic control module/unit (ECM/U)) coupled to the vehicle, the controller configured to: (1) control the on/off state (or operational status) of the ICE, (2) control rotation of the ICE through a clutch actuator or automatic transmission controller, and (3) control the on/off state of an electric motor, the electric motor coupled to the PTO to drive a transmission of the vehicle, thereby moving the vehicle independent of the state of the ICE. In some embodiments, a gearbox may be interposed between the PTO and the electric motor.

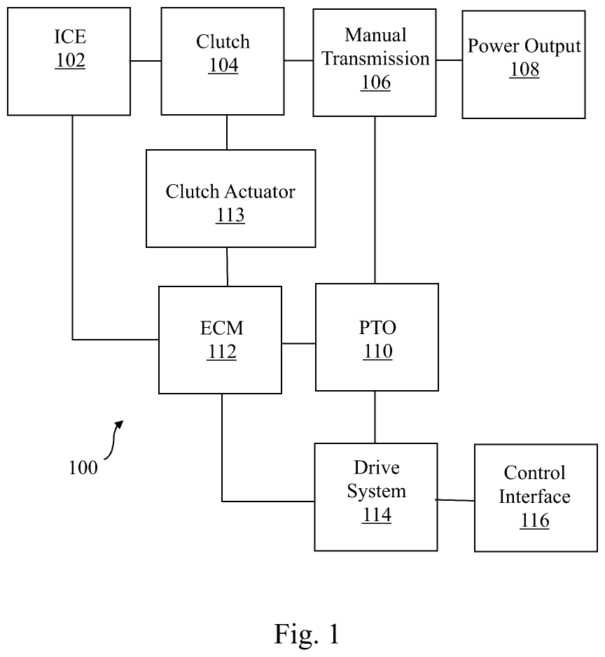

For example, referring to FIG. 1, in some embodiments, in vehicles with a manual transmission, a hybrid system 100 comprises an ICE 102, a clutch 104, a manual transmission 106, power output 108 (e.g., driveshaft), a PTO 110 coupled to the transmission 106, an ECM/U 112 coupled to both the ICE 102 and the PTO 110, a drive system 114 (which may comprise an electric motor, battery, and battery management system) coupled to the PTO 110, and a control interface 116 (e.g., user input/output such as buttons, screens, switches, wireless transceivers, etc.).

In some embodiments, a gearbox may be coupled between the electric motor of the drive system 114 and the PTO 110, allowing for varying gear ratios. It will be appreciated that additional components may be included herewith, such as cooling systems (e.g., motor cooling systems), an electric hydraulic pump or power steering or other hydraulic systems, electric HVAC for cab comfort and climate control, electric air compressor for air supply, one or more isolation monitoring devices (IMDs), and one or more safety sensors and/or device sensors (e.g., temperature sensors, pressure sensors, battery SOC monitors, etc.).

The ECM/U 112 of the hybrid system 100, in some embodiments, may be configured to electronically control the connection/disconnection of the PTO 110 as well as controlling the clutch 104 engagement/disengagement, such as via a clutch actuator 113, based upon power demand from the driver, battery state of charge, operating temperatures, malfunctions, etc. The ECM/U 112 is also configured to control the start/stop status of the ICE 102.

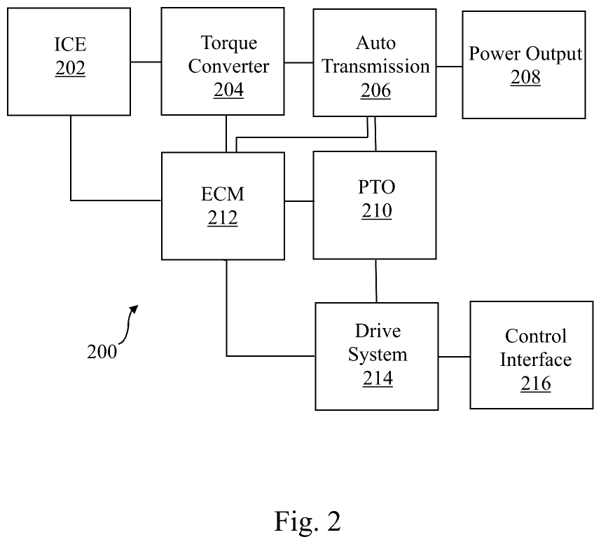

Referring to FIG. 2, in some embodiments, in vehicles with an automatic transmission, a hybrid system 200 comprises an ICE 202, a torque converter 204, an automatic transmission 206, power output 208 (e.g., driveshaft), a PTO 210 coupled to the transmission 206, an ECM/U 212 coupled to 1) the ICE 202, 2) the PTO 210, and 3) the torque converter 204, a drive system 214 (which may comprise an electric motor, at least one battery, and a battery management system) coupled to the PTO 210, and a control interface 216 (e.g., user input/output such as buttons, screens, switches, wireless transceivers, etc.).

The ECM/U 212 of the hybrid system 200, in some embodiments, may be configured to electronically control the connection/disconnection of the PTO 210 as well as controlling the torque converter 204 engagement/disengagement and gear selection of the automatic transmission 206 based upon power demand from the driver, battery state of charge, operating temperatures, malfunctions, etc. The ECM/U 212 is also configured to control the start/stop status of the ICE 202.

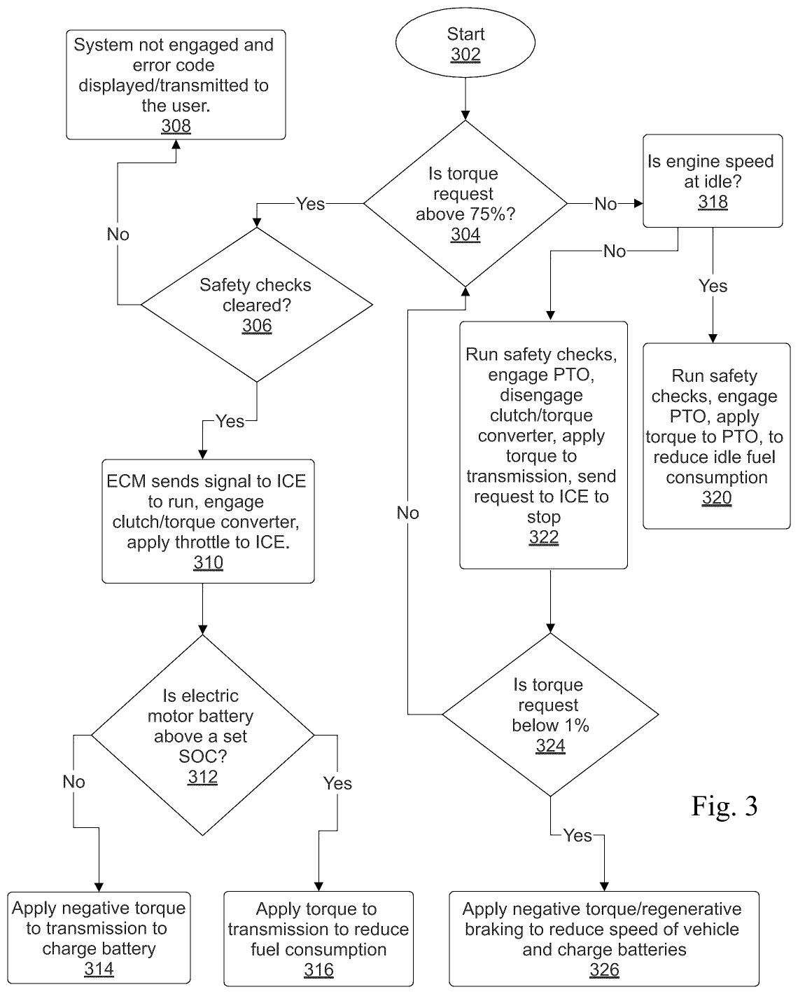

Referring to FIG. 3, in some methods of use, the hybrid system 100, 200 may comprise the following steps: at step 302, the system initiates (e.g., is powered on) and the ECM/U reads the status of the vehicle (e.g., is the ICE operating, SOC of batteries, electric motor on/off status, etc.) and the various vehicle components; at step 304, if the torque is above 75%, the system initiates safety checks by processing information from one or more sensors (e.g., temperatures, pressures, etc.). If the safety checks are not cleared (e.g., temperature of electric motor above a predetermined threshold), the system does not engage the drive system 116/216 or other systems and, at 308, displays or transmits the error/fault code to the user via the interface control 116.

If the safety checks are cleared in 306, then in step 310 the ECM/U sends a signal to run the ICE 102/202 and engage the clutch 104/torque converter 204, and apply the throttle to the ICE 102/202. In step 312, if the battery (i.e., one or more batteries for powering the electric motor of the drive system 116/216) is below a predetermined threshold, then at step 314 a negative torque is applied to the transmission to charge the batteries. If the state of charge is above a predetermined state of charge, then at step 316 the electric motor of the drive system 116/216 may apply torque to the transmission 106/206 via the PTO 110/210 to reduce fuel consumption by the ICE 102/202.

Returning to step 304, if the torque request is less than 75% (or other threshold set by the user), the system determines, at step 318, if the ICE 102/202 is at idle speed. If at idle, then at step 320, if safety checks are cleared, the ECM/U engages the PTO 110/210 and the electric motor of the drive system 114/214 applies torque to the PTO 110/210 to reduce fuel consumption. The ECM/U may be configured to shut off fuel injectors to the ICE 102/202, reducing fuel consumption while at idle. Returning to step 304, if the system determines that the ICE 102/202 is not at idle, then at step 322, if safety checks are cleared, the ECM/U 112/212 engages the PTO 110/210, disengages the clutch 104/torque converter 206, stops the ICE 102/202, and the electric motor of the drive system 114/214 applies torque to the transmission 106/206. At step 324, the system determines if the torque request is below 1%. If the torque request is below 1% (or other threshold set by the user), then at step 326 a negative torque is applied, along with regenerative braking, to thereby reduce the speed of the vehicle while simultaneously charging the batteries of the drive system 114/214. If the torque request is above 1%, then system returns to step 304 to cycle again.

In some embodiments, a hybrid system comprises an electric motor, a motor controller, a water cooling system, and ECM/U, a clutch actuator (for manual transmissions), a PTO air/electric solenoid, an electric hydraulic pump for power steering, an electric heater/air conditioner for climate control, an electric air compressor for air supply, a battery with a battery management system (BMS), an isolation monitoring device (IMD), and hood/enclosures with safety switches.

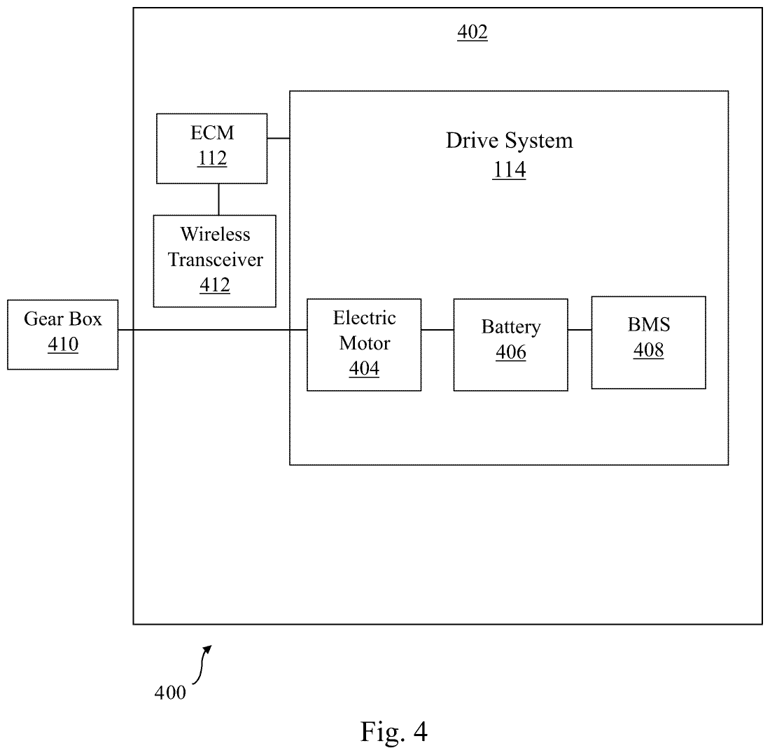

It will be appreciated that a vehicle may be manufactured with the hybrid system 100/200 assembled during the manufacturing process. However, it will also be appreciated that the hybrid system disclosed herein may be configured as an aftermarket kit that is configured to be couplable to an ICE vehicle. For example, as shown in FIG. 4, a hybrid system 400 configured as an aftermarket kit may comprise a system enclosure 402 configured to house an ECM 112/212 and the drive system 114/214. As discussed earlier, the drive system 114/214 may comprise an electric motor 404, at least one battery 406 for powering the electric motor 404, and a battery management system 408 configured to charge the at least one battery. The output shaft of the electric motor may be configured to couple to the PTO 110/210 of the ICE vehicle. In some embodiments, the aftermarket kit may further comprise a gearbox 410 configured to be interposed between the output shaft of the electric motor and the PTO 110/210.

In some embodiments, the system enclosure 402 comprises a wireless transceiver 412, which may likewise be housed in the system enclosure 402 as shown in FIG. 4. The wireless transceiver 412 is configured to transmit and receive data via known wireless protocols (e.g., Bluetooth®, Wi-Fi®, cellular, etc.). Accordingly, a user may use a wireless device (e.g., smartphone, tablet, computer, etc.) to communicate with the hybrid system 100/200 via the wireless transceiver 412, which is coupled to the ECM 112/212, the combination of which functions as the control interface 100/200. In some embodiments, the control interface 100/200 may be a wired input/output device, such as a touchscreen, buttons, lights, switches, etc. In such embodiments, the control interface 100/200 may be placed in the cab of the vehicle, with the wired connection traversing through the vehicle to be coupled to the ECM 112/212 of the hybrid system 100/200.

While ECM/U is used as an example throughout, it will be appreciated that other controllers or processors may be used without departing herefrom, including microcontrollers and other processors.

Accordingly, it will be appreciated from the foregoing that the hybrid system disclosed herein solves the need for a hybrid system for commercial trucks that is capable of reducing fuel consumption, reducing harmful emissions, reducing wear on the ICE and drivetrain, while increasing power availability.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A hybrid system for a vehicle, comprising:
a drive system, comprising:
an electric motor, and
at least one battery;
an electronic control module;
wherein, the electric motor is configured to be coupled to a power takeoff of the vehicle; and
wherein the electronic control module is configured to control an on/off status of the electric motor, an operational status of an internal combustion engine, and the operational status of the power takeoff.

2. The hybrid system of claim 1, further comprising a clutch actuator configured to be interposed between a clutch of the vehicle and the electronic control module, the electronic control module configured to control the clutch via the clutch actuator.

3. The hybrid system of claim 1, wherein the electronic control module is configured to be coupled to a torque converter and an automatic transmission of the vehicle, the electronic control module configured to control an operation of the torque converter and the automatic transmission.

4. The hybrid system of claim 1, wherein the drive system and the electronic control module are positioned within a hybrid enclosure.

5. The hybrid system of claim 1, further comprising a gearbox interposed between the electric motor and the power takeoff.

6. The hybrid system of claim 1, further comprising a control interface.

7. The hybrid system of claim 6, wherein the control interface comprises a wireless transceiver coupled to the electronic control module.

8. A hybrid system for a vehicle, comprising:
a drive system, comprising:
an electric motor,
at least one battery, and
a battery management system;
an electronic control module coupled to the drive system;
a control interface; and
a gearbox interposed between the electric motor and a power takeoff, the power takeoff coupled to a transmission of the vehicle;
wherein the electronic control module is configured to control the on/off status of the electric motor, the operational status of an internal combustion engine of the vehicle, and the operational status of the power takeoff.

9. The hybrid system of claim 8, further comprising a clutch actuator configured to be interposed between a clutch of the vehicle and the electronic control module, the electronic control module configured to control the clutch via the clutch actuator.

10. The hybrid system of claim 8, wherein the electronic control module is configured to be coupled to a torque converter and automatic transmission of the vehicle, the electronic control module configured to control the operation of the torque converter and automatic transmission.

11. The hybrid system of claim 8, wherein the drive system and the electronic control module are positioned within a hybrid enclosure.

12. The hybrid system of claim 8, wherein the control interface comprises a wireless transceiver coupled to the electronic control module.

13. A method of using a hybrid system for a vehicle, the method comprising:
using an electronic control module to monitor a torque demand, an operational status of an internal combustion engine, and a status of one or more sensors;
using an electric motor to selectively drive a power takeoff; and
using the electronic control module to:
i. control an on/off status of the electric motor, the electric motor coupled to the power takeoff of the vehicle,
ii. engage or disengage a clutch or a torque converter,
iii. apply torque or negative torque to a transmission via the electric motor,
iv. control the operational status of the internal combustion engine, and
v. control a throttle of the vehicle.

14. The method of claim 13, wherein when a battery coupled to, and configured to power, the electric motor is below a first threshold, using the electronic control module to apply a negative torque to the transmission to charge the battery.

15. The method of claim 13, wherein when a battery coupled to, and configured to power, the electric motor is above a first threshold, using the electronic control module to apply a torque to the transmission to reduce fuel consumption.

16. The method of claim 13, wherein when the internal combustion engine is at an idle, using the electric motor to apply a torque to the power takeoff to reduce fuel consumption.

17. The method of claim 16, wherein the electronic control module is further configured to shut off on or more fuel injectors of the internal combustion engine.
